(19) United States
(12) Patent Application Publication
(10) Pub. No.: US 2025/0328211 A1
(43) Pub. Date: Oct. 23, 2025

(54) INFORMATION PRESENTING METHOD, APPARATUS, DEVICE, AND STORAGE MEDIUM

(71) Applicant: Beijing Zitiao Network Technology Co., Ltd., Beijing (CN)

(72) Inventors: Fujia LIU, Beijing (CN); Siyi LIU, Beijing (CN)

(21) Appl. No.: 18/873,303

(22) PCT Filed: Sep. 26, 2023
(86) PCT No.: PCT/CN2023/121521

§ 371 Date: Dec. 9, 2024

(30) Foreign Application Priority Data
Oct. 9, 2022 (CN) 202211226869.9

(51) Int. Cl. G06F 3/0481; G06F 9/451

(52) U.S. Cl. CPC G06F 3/0481; G06F 9/451

(57) ABSTRACT

Disclosed herein are an information presenting method and apparatus, a device, and a storage medium. The information presenting method includes: in response to that a preset entry is triggered, determining target associated information corresponding to the preset entry, wherein the target associated information comprises associated information having a preset interaction relationship with a current user and comprising information associated with a preset content; and displaying a target interface, wherein the target interface is configured to present at least one piece of target associated information.

The present disclosure claims the priority from the CN patent application No. 202211226869.9 filed with the China National Intellectual Property Administration (CNIPA) on Oct. 9, 2022, the contents of which are hereby incorporated by reference in their entireties.

### FIELD

The present disclosure relates to the technical field of computers, for example, an information presenting method and apparatus, a device, and a storage medium.

### BACKGROUND

The rapid development of Internet technology has spawned lots of applications which provide users more diversified interaction methods and interaction experience.

In some application platforms, a user can post contents in various forms such as text, pictures, audios or videos for others to view, and some contents may have associated information that can also be presented on the interface. However, such information presenting method is not satisfactory enough and needs improvements.

### SUMMARY

The present disclosure provides an information presenting method and apparatus, a storage medium, and a device.

In a first aspect, the present disclosure provides an information presenting method, comprising:
in response to that a preset entry is triggered, determining target associated information corresponding to the preset entry, wherein the target associated information comprises associated information having a preset interaction relationship with a current user and comprising information associated with a preset content; and
displaying a target interface, wherein the target interface is configured present at least one piece of target associated information.

In a second aspect, the present disclosure provides an information presenting apparatus, comprising:
a target associated information determining module configured to, in response to that a preset entry is triggered, determine target associated information corresponding to the preset entry, wherein the target associated information comprises associated information having a preset interaction relationship with a current user and comprising information associated with a preset content; and
a target interface display module configured to display a target interface, wherein the target interface is configured present at least one piece of target associated information.

In a third aspect, the present disclosure provides an electronic device, comprising:
one or more processors; and
a memory configured to store one or more programs;
wherein the one or more programs, when executed by the one or more processors, cause the one or more processors to implement the information presenting method.

In a fourth aspect, the present disclosure further provides a storage medium comprising computer executable instructions which implement the information presenting method when executed by a computer processor.

In a fifth aspect, the present disclosure further provides a computer program product comprising a computer program carried on a non-transitory computer readable medium, wherein the computer program comprises program code for executing the information presenting method.

### BRIEF DESCRIPTION OF THE DRAWINGS

FIG. 1 illustrates a schematic flowchart of an information presenting method provided by embodiments of the present disclosure;

FIG. 2 illustrates a schematic diagram of interface interaction provided by embodiments of the present disclosure;

FIG. 3 illustrates a schematic diagram of an interface provided by embodiments of the present disclosure;

FIG. 4 illustrates a schematic flowchart of another information presenting method provided by embodiments of the present disclosure;

FIG. 5 illustrates a schematic diagram of another interface interaction provided by embodiments of the present disclosure;

FIG. 6 illustrates a schematic flowchart of a further information presenting method provided by embodiments of the present disclosure;

FIG. 7 illustrates a schematic diagram of further interface interaction provided by embodiments of the present disclosure;

FIG. 8 illustrates a schematic diagram of still further interface interaction provided by embodiments of the present disclosure;

FIG. 9 illustrates a schematic diagram of a structure of an information presenting apparatus provided by embodiments of the present disclosure; and

FIG. 10 illustrates a schematic diagram of a structure of an electronic device provided by embodiments of the present disclosure.

### DETAILED DESCRIPTION OF EMBODIMENTS

Reference now will be made to the drawings to describe the embodiments of the present disclosure. Although the drawings depict some embodiments of the present disclosure, the present disclosure can be implemented in various forms, and those embodiments are provided only for ease of understanding on the present disclosure. The drawings and embodiments of the present disclosure are only provided exemplarily.

It is to be understood that respective steps in the implementations of the method according to the present disclosure may be performed in different orders and/or performed in parallel. In addition, the method implementations may include additional steps and/or steps omitted. The scope of the present disclosure is not limited in the aspect.

As used herein, the term “includes” and its variants are to be read as open-ended terms that mean “comprises.” The term “based on” is to be read as “based at least in part on.” The term “an embodiment” is to be read as “at least one embodiment;” the term “another embodiment” is to be read as “at least one further embodiment;” the term “some embodiments” is to be read as “at least some embodiments.” Related definitions of other terms will be provided in the description below.

It should be noted that, the terms “first,” “second” and the like mentioned in the present disclosure are only configured distinguish different apparatuses, modules or units, rather than limit an order of functions performed by the apparatus, module or unit or limit interdependence.

It should be noted that, the terms “one” and “a plurality of” mentioned in the present disclosure are illustrative, not restrictive, and should be understood as “one or more” by those skilled in the art, unless explicitly specified otherwise in the context.

Names of messages or information interacted between a plurality of apparatuses in the embodiments of the present disclosure are illustrative rather than limit the scope of the messages or information.

Prior to applying the technical solution according to various embodiments of the present disclosure, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers, or storage media that perform operations of the technical solution of the present disclosure.

As an optional implementation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, and other methods compliant with the provisions of the relevant laws and regulations can also be applied to the implementations of the present disclosure.

The data (including data per se, and acquisition or application of the data) involved in the present technical solution should comply with the provisions of the corresponding laws and regulations as well as relevant stipulations.

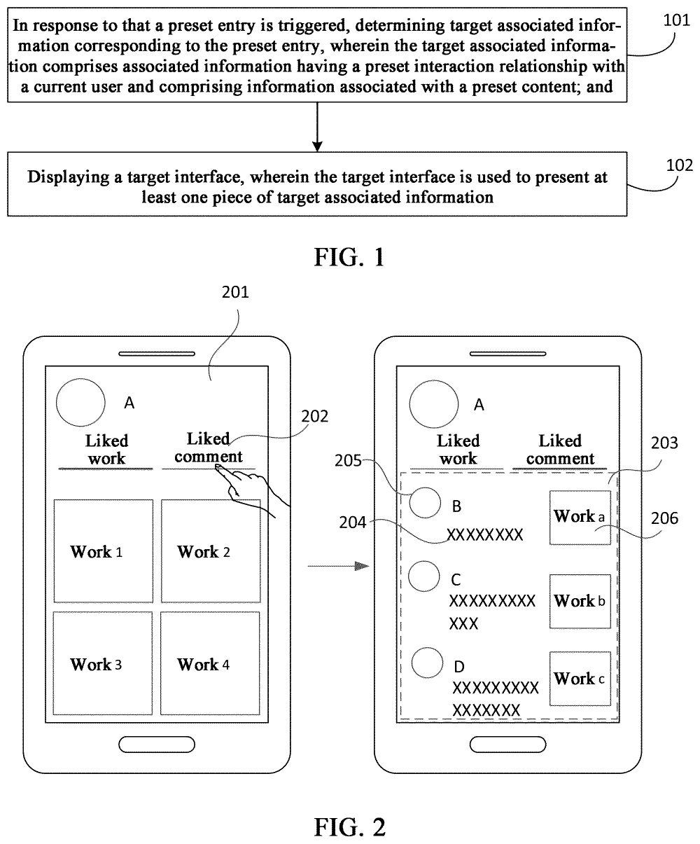

FIG. 1 illustrates a schematic flowchart of an information presenting method provided by embodiments of the present disclosure. The embodiments of the present disclosure are applicable to scenarios of presenting information. The method can be implemented in the form of software and/or hardware, for example, by an electronic device which may be a mobile terminal such as a mobile phone, a smart watch, a tablet computer and a personal digital assistant, or a device such as a Personal Computer (PC), a server or the like.

As shown therein, the method includes:

Step 101: in response to that a preset entry is triggered, determining target associated information corresponding to the preset entry, wherein the target associated information comprises associated information having a preset interaction relationship with a current user and comprising information associated with a preset content

In the embodiments of the present disclosure, the preset entry may be an entry control displayed on a preset interface which may be a interface in a preset application that can provide a content presenting function. The type of the preset application is not limited herein, which may include, for example, a video application, a social application, an information application, an instant messaging application, or the like, and the preset application may be installed in an electronic device. Wherein, the preset interface may be a personal homeinterface or a message list interface of the current user, or the like, and the type of the interface is not limited herein.

For example, the preset content may be a content provided by the preset application, or may be a content posted by a user through the preset application. The form of the preset content is not limited herein, which may include text, pictures, audios, videos or the like. The preset content may include a preset media work such as a video work, 1 text-picture work, a music work or the like.

By way of example, the associated information includes information associated with the preset content, and the association manner is not limited herein. For example, the association manner may be that a user has posted a comment on the preset content, i.e., the associated information may include comment information (also referred to as first-level comment information). For another example, the association manner may be that a user has commented a comment on the preset content, which may also be read as that comment information has been posted to reply to a comment on the preset content, i.e., the associated information may include comment information, where the comment information may also be referred to as N-level comment information (N is an integer greater than or equal to 2) or comment reply information.

As an example, the target associated information may include associated information having a preset interaction relationship with the current user in all or a part of associated information in the preset application, where the part of associated information may include associated information existing within a specified time limit, associated information corresponding to a preset content posted within a specified time limit, or the like. The preset interaction relationship is not limited herein. For example, the preset interaction relationship may include that a user has input a preset interaction operation for the associated information, where the preset interaction operation includes at least one of a like operation, an operation of adding to favorites, a mark operation, and a forwarding operation.

By way of example, after the preset entry is triggered, the target associated information currently corresponding to the preset entry can be determined, where a number of pieces of the determined target associated information can be determined as actually required, which may be 0, 1 or more.

Step 102: displaying a target interface, wherein the target interface is configured present at least one piece of target associated information.

By way of example, after the preset entry is triggered, a target interface is displayed, which is configured present at least one piece of target associated information. In a case where the number of pieces of the determined target associated information is 0, the target interface may present prompt information for indicating that target associated information is absent at present, for example, “there is no liked comment,” or the like.

For the target associated information, due to the preset interaction relationship with the current user, the current user may have a need for a return visit. A preset entry is provided to enable the user to trigger a display of the target interface by triggering the preset entry, thus implementing a return visit to the target associated information.

By way of example, the target interface may be a interface different than the preset interface, and displaying the target interface may include jumping from the preset interface to the target interface. The target interface may be a sub-interface on the preset interface, for example, a tag interface. At least one interface tag may be displayed on the preset interface, and the preset entry may be a interface tag therein. After the interface tag, as the preset entry described above, has been triggered, the tag interface acting as the target interface is displayed on the preset interface.

As an example, FIG. 2 illustrates a schematic diagram of interface interaction provided by embodiments of the present disclosure. As shown therein, assumed that the preset interface is a personal homeinterface 201 of a user A (current user), a preset entry 202 is displayed on the personal homeinterface 201, which may be a interface tag of “liked comment.” After the current user triggers the preset entry 202, a target interface 203 is displayed, and at least one piece of target associated information (e.g. 3 pieces in FIG. 2) is displayed on the target interface 203.

The information presenting method provided by the embodiments includes: in response to that a preset entry is triggered, determining target associated information corresponding to the preset entry, wherein the target associated information includes associated information having a preset interaction relationship with a current user and containing information associated with a preset content; and displaying a target interface for presenting at least one piece of target associated information. According to the aforesaid technical solution, a preset entry is provided to enable a current user to conveniently view information associated with a preset content and having a preset interaction relationship with himself/herself, thereby making the associated-information presenting methods more diversified, meeting the user's need for a return visit to target associated information, and improving the interaction efficiency.

In some embodiments, after displaying the target interface, the method further includes: presenting at least one piece of the target associated information on the target interface. Such arrangement has the advantage of directly presenting the target associated information after entering the target interface, to improve the presenting efficiency.

By way of example, in a case of determining that there is target associated information corresponding to the preset entry, at least one piece of the target associated information is presented on the target interface. Wherein, the target associated information may be presented piece by piece or in batches, which is not limited herein.

By way of example, when presenting the target associated information, information related to the target associated information may also be presented, for example, a user identifier (e.g. a user name, a user alias, a user avatar or the like) of a target user, or a content identifier of the preset content (e.g. a summary of the preset content, a screenshot or cover image of the preset content or the like) corresponding to the target associated information. As shown in FIG. 2, when the target associated information 204 is being presented on the target interface 203, a user identifier 205 of a user B who posted target associated information 204, and/or a content identifier 206 of a preset content (a work) corresponding to the target associated information 204, for example, a cover image of a work a may also be presented.

In some embodiments, the method further includes: in a case where presented first target associated information meets a first preset requirement, first preset prompt information is displayed on a first associated position of the first target associated information, where the first preset prompt information is configured indicate that the first target associated information contains new interaction information that includes interaction information posted after the preset interaction relationship being formed. Such arrangement has the advantage of: enabling a user to intuitively learn associated information having the preset interaction relationship with himself/herself and determine presence or absence of newly posted interaction information after the preset interaction relationship being formed, to determine whether a view operation or the like is to be performed.

For example, the interaction information may include information on interaction with the target associated information, which may include, for example, N-level comment information or comment reply information, as described above.

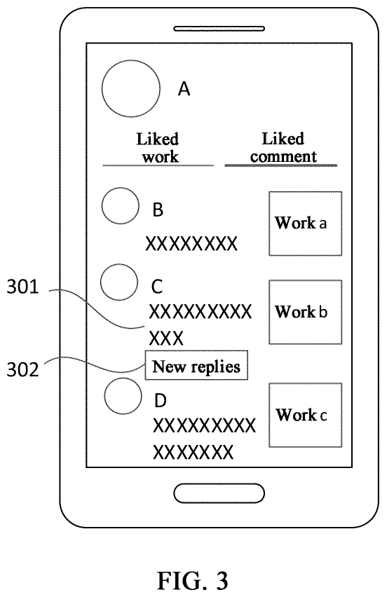

As an example, the first associated position is not limited herein, which may be below, or on the right side of, the first target associated information, for example; the first preset prompt information is configured indicate that the first target associated information contains new interaction information, where the content of the first preset prompt information is not limited. FIG. 3 illustrates a schematic diagram of an interface provided by embodiments of the present disclosure. As shown therein, when first target associated information 301 is being displayed on the target interface, first preset prompt information 302, for example, “new reply,” is displayed below the first target associated information 301. The first preset prompt information includes: a number of pieces of new interaction information. Such arrangement has the advantage of: providing clear prompt information to the current user so that the user can refer to the first preset prompt information to determine whether to view the new interaction information.

In some embodiments, the new interaction information includes interaction information posted after the preset interaction relationship being formed and having not been viewed by the current user; and/or the new interaction information includes interaction information posted after the preset interaction relationship being formed and meeting a preset presenting condition. Such arrangement has the advantage of: reasonably defining new interaction information, reducing the chances of presenting unnecessary first preset prompt information, and improving the efficiency of the current user viewing the first preset prompt information.

By way of example, newly posted interaction information having been viewed by the current user may be not considered as new interaction information, nor may newly posted interaction information not meeting the preset presenting condition be considered as new interaction information. The preset presenting condition includes: not including a second preset character, and/or including more than preset image information. The second preset character may include, for example, a preset prompt character (e.g. “@” or the like), a preset trigger word (e.g. a character that a user uses to trigger an Easter egg or a special effect) or the like. If a preset prompt character is included, the current user is typically notified in the form of a push message or the like; if a preset trigger word is included, this can reduce the time that the current user spends on viewing this type of interaction message. Wherein, the preset image information may be, for example, an emoticon. If the preset image information includes an emoticon only, this can reduce the time that the current user spends on viewing this type of interaction message.

For example, the first target associated information may be any piece of target associated information meeting the first preset requirement. The first preset requirement may be set as actually required, for example, which may be all target associated information, or may be set based on an attribute (e.g. a posting time, or the like) of the target associated information, an operation (e.g., viewed or not, or the like) that the current user performs for the target associated information, or the like.

In some embodiments, the first preset requirement includes at least one of the following: for historical interaction information for the first target associated information, the current user has performed a view operation meeting a first preset condition; for the first target associated information, the current user has performed an interaction operation; and an effective duration of the first preset prompt information corresponding to the first target associated information is less than a first preset duration. This arrangement has the advantage of: reasonably filtering target associated information to be displayed in the first preset prompt information, reducing chances of displaying unnecessary first preset prompt information, and improving the efficiency of the current user viewing the first preset prompt information.

In the embodiments of the present disclosure, the operation of obtaining related data (e.g. view-operation data for the historical interaction information) required for determining whether the first preset requirement is met is performed in a case where the user is informed and gives his/her authorization.

By way of example, the historical interaction information may include interaction information already existing when the current user viewed the interaction information of the first target association information last time. Having performed the view operation meeting the first preset condition may include: having performed the view operation for a first preset number or a first preset proportion of the historical interaction information. The first preset number and the first preset proportion may be set as actually required, for example, respectively to 20 pieces and 100% or 90%, or the like. If the current user has viewed a certain number or a certain proportion of historical interaction information, it is considered necessary to give the current user a prompt for the new interaction information.

As an example, having performed an interaction operation may include having posted interaction information, for example. If the current user has posted interaction information for the first target associated information, it can be considered that the current user has a high participation degree for the first target associated information, and a necessity is determined to give the current user a prompt for the new interaction information.

For example, the effective duration may be a duration lasting for prompting the current user. The first preset duration can be set as actually required, for example, to 60 days. Within 60 days after the first preset prompt information is debuted, if the current user has not viewed the new interaction information, entering the target interface can be performed again, and the first preset prompt information can continue to be displayed. If the duration reaches 60 days and the current user has not viewed the new interaction information, display of the first preset prompt information can be cancelled, i.e., entering the target interface can be performed again, and the first preset prompt information is not displayed.

In some embodiments, in the case where the presented first target associated information meets the first preset requirement, displaying the first preset prompt information on the first associated position of the first target associated information, includes: in a case where the presented first target associated information meets the first preset requirement but does not meet a first preset filtering condition, displaying the first preset prompt information on the first associated position of the first target associated information. Such arrangement has the advantage of: on the basis of setting the first preset requirement, setting the first preset filtering condition, and if the first preset filtering condition is not hit, displaying the first preset prompt information, and reasonably displaying the first preset prompt information.

The first preset filtering condition includes: a poster of the first target associated information and/or a poster of a preset content corresponding to the first target associated information has a preset association relationship with the current user. Such arrangement has the advantage of: reasonably setting the first preset filtering condition.

By way of example, the preset association relationship may be a follow-up relationship or a friend relationship in a preset application, for example. If there exists a preset association relationship, new interaction information is typically notified to the current user in the form of a push message or the like, to reduce redundant notifications of new interaction information.

In some embodiments, after displaying the first preset prompt information, the method further includes: in response to a trigger operation for the first preset prompt information, entering a first preset presenting interface; and presenting at least one piece of the new interaction information on the first preset presenting interface. Such arrangement has the advantage of: enabling a user to quickly view a new interaction message. If a plurality of pieces of new interaction information is presented, presenting is implemented in an ascending or descending chronological order.

In some embodiments, presenting at least one piece of the new interaction information on the first preset presenting interface includes: presenting the first target associated information and the at least one piece of the new interaction information on the first preset presenting interface. Such arrangement has the advantage of: concurrently presenting first target associated information and a new interaction message of the first target associated information, and forming a presenting format similar to a dialogue tree with the first target associated information as a root and the new interaction message as branches and leaves, to enable a user to have a comprehensive picture of the interaction process.

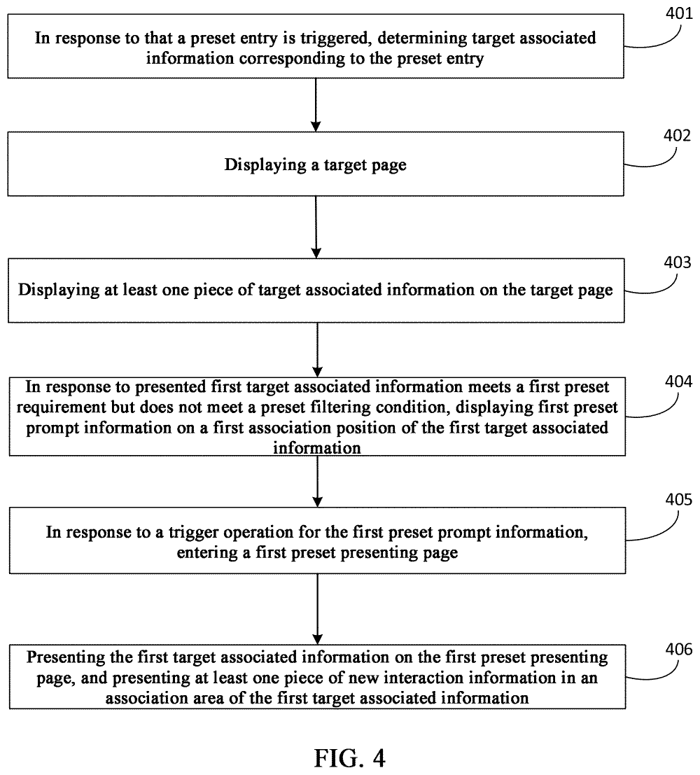

FIG. 4 illustrates a schematic flowchart of another information presenting method provided by embodiments of the present disclosure where description will be made on the basis of the solution according to the embodiments described above. The method includes the following steps:

Step 401: in response to that the preset entry is triggered, determining the target associated information corresponding to the preset entry.

The associated information includes information associated with the preset content, and the target associated information includes associated information having a preset interaction relationship with the current user.

By way of example, the preset content is a preset media work, the associated information is comment information, and the preset interaction relationship is that a user has liked the comment.

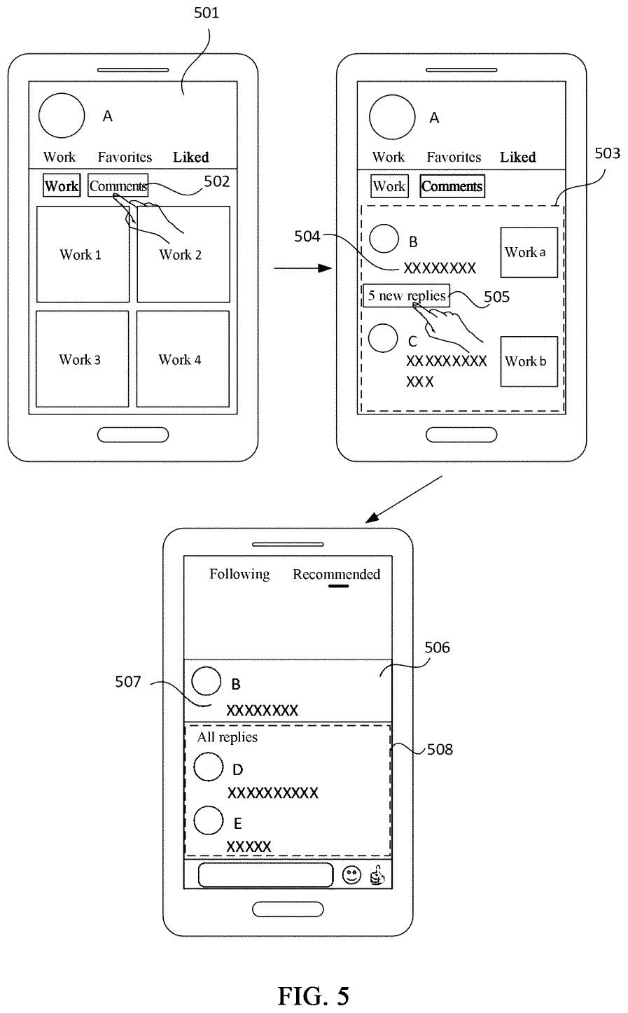

FIG. 5 illustrates a schematic diagram of another interface interaction provided by embodiments of the present disclosure. As shown therein, a preset entry 502 (assumed that it is a comment sub-interface tag under a liked interface tag) is displayed on a preset interface 501 (assuming that it is a personal homeinterface of a user A), and after the user clicks on the preset entry 502, target associated information corresponding to the preset entry 502 is determined, i.e., comment information that the user A has liked is determined.

Step 402: displaying the target interface.

As shown in FIG. 5, after the user clicks on the preset entry 502, entering the target interface 503 is implemented.

Step 403: displaying at least one piece of target associated information on the target interface.

As shown in FIG. 5, in the presence of the target associated information corresponding to the preset entry 502, at least one piece of target associated information is presented on the target interface 503, where two pieces of comment information liked by the user A is presented as an example in the figure.

Step 404: in a case where the presented first target associated information meets the first preset requirement but does not meet the preset filtering condition, displaying the first preset prompt information on the first associated position of the first target associated information.

The first preset prompt information is configured indicate that the first target associated information contains new interaction information, where the new interaction information contains interaction information posted after the preset interaction relationship had not been formed, having not been viewed by the current user, and meeting the preset presenting condition. The interaction information may a reply to a comment. The preset prompt information includes a number of pieces of new interaction information.

As shown in FIG. 5, if the presented first target associated information 504 (comment information posted by a user B) meets the first preset requirement (for example, the user A has exhausted all replies existing at that time when viewing the replies of the first target associated information last time, or the user A has replied to the first target associated information 504), it is considered that the first target associated information 504 meets the first preset requirement. If the user A does not have the preset associated relationship with the user B, or with the poster of the work a, it is considered that the first target associated information 504 does not meet the first preset filtering condition. The first preset prompt information 505 is displayed on the first associated position of the first target associated information 504, for example, below the first associated information 504, and the first preset prompt information 505 may be a number of pieces of new interaction information, for example, “new 5 replies” as shown in FIG. 5.

Step 405, in response to a trigger operation for the first preset prompt information, entering the first preset presenting interface.

As shown in FIG. 5, after the user clicks on the first preset prompt information 505, entering the first preset display interface 506 is implemented. The first preset display interface 506 may be a comment interface (also referred to as comments panel) on the present content presenting interface, for example, a comments panel on the presenting interface of the work a.

Step 406: presenting the first target associated information on the first preset presenting interface, and presenting at least one piece of new interaction information in an association area of the first target associated information.

As shown in FIG. 5, the first target associated information 504 is presented in an information presenting area 507 in the first preset presenting interface 506, and at least one piece of new comment reply information is presented in the association area 508 (e.g. a comment reply area) of the first target associated information.

By way of example, after entering the first preset presenting interface, the new interaction information is presented on the pinned position in the association area of the first target associated information, and after the user inputs a switch operation such as swipe or the like, historical interaction information may be presented.

The information presenting method provided by embodiments of the present disclosure includes: in response to that that the preset entry is triggered, determining the target associated information corresponding to the preset entry; displaying the target interface; displaying at least one piece of target associated information on the target interface; in a case where the presented first target associated information meets the first preset requirement but does not meet the preset filtering condition, displaying the first preset prompt information on the first associated position of the first target associated information to prompt the user of the new interaction information; after the user triggers the first preset prompt information, quickly jumping to the first preset presenting interface, to display the first target associated information and the new interaction information in association. In this way, the method can enable a user to quickly view new interaction information, meet the user's need for a convenient return visit to the target associated information and interaction information of the target associated information, and improve the interaction efficiency.

In some embodiments, the method further includes: in a case where presented second target associated information meets a second preset requirement, second preset prompt information is displayed on a second associated position of the second target associated information, where the second preset prompt information is configured indicate that a preset content corresponding to the second target associated information contains new associated information that includes associated information posted after the preset interaction relationship being formed. Such arrangement has the advantage of: enabling a user to intuitively learn associated information having the preset interaction relationship with himself/herself and determine presence or absence of newly posted interaction information after the preset interaction relationship being formed, to determine whether a view operation or the like is to be performed.

By way of example, the second associated position is not limited herein, which may be below, or on the right side of, the second target associated information, for example; the second preset prompt information is configured indicate that a preset content corresponding to the second target associated information contains new associated information, where the content of the second preset prompt information is not limited, for example, “a new comment.” The second preset prompt information includes: a number of pieces of new associated information. Such arrangement has the advantage of: providing clear prompt information to the current user so that the user can refer to the second preset prompt information to determine whether to view the new associated information.

In some embodiments, the new associated information includes associated information posted after the preset interaction relationship being formed and having not been viewed by the current user; and/or the new associated information contains associated information posted after the preset interaction relationship being formed and meeting a preset presenting condition. Such arrangement has the advantage of: reasonably defining new associated information, reducing the chances of presenting unnecessary second preset prompt information, and improving the efficiency of the current user viewing the second preset prompt information.

By way of example, newly posted associated information having been viewed by the current user may not not considered as new associated information, nor may newly posted associated information not meeting the preset presenting condition be considered as new associated information. The preset presenting condition includes: not including a second preset character, and/or including more than preset image information. The second preset character may include, for example, a preset prompt character (e.g. “@” or the like), a preset trigger word (e.g. a character that a user uses to trigger an Easter egg or a special effect) or the like. If a preset prompt character is included, the current user is typically notified in the form of a push message or the like; if a preset trigger word is included, this can reduce the time that the current user spends on viewing this type of associated message. Wherein, the preset image information may be, for example, an emoticon. If the preset image information includes an emoticon only, this can reduce the time that the current user spends on viewing this type of associated message.

For example, the second target associated information may be any piece of target associated information meeting the second preset requirement. The second preset requirement may be set as actually required, for example, which may be all target associated information, or may be set based on an attribute (e.g. a posting time, or the like) of the target associated information, an operation (e.g., viewed or not, or the like) that the current user performs for the target associated information, or the like. The second target associated information and the first target associated information may be the same target associated information, i.e., for the same target associated information, the first preset prompt information can be displayed on the first associated position while the second preset associated information is displayed simultaneous on the second associated position. For the same target associated information, it is required to display one of the first preset prompt information and the second preset prompt information, and the first associated position and the second associated position may be the same associated position, for example, below the target associated information.

In some embodiments, the second preset requirement includes at least one of the following: for historical associated information of a preset content corresponding to the second target associated information, the current user has performed a view operation meeting a second preset condition; a view operation performed by the current user for historical associated information of a preset content corresponding to the second target associated information meets a third preset condition; for a preset content corresponding to the second target associated information, the current user has posted associated information containing a first preset character; and an effective duration of the second preset prompt information corresponding to the second target associated information is less than a second preset duration. This arrangement has the advantage of: reasonably filtering target associated information to be displayed in the second preset prompt information, reducing chances of displaying unnecessary second preset prompt information, and improving the efficiency of the current user viewing the second preset prompt information.

In the embodiments of the present disclosure, the operation of obtaining related data (e.g. view-operation data for the historical interaction information) required for determining whether the second preset requirement is met is performed in a case where the user has been informed and given his/her authorization.

As an example, the historical interaction information may include associated information already existing when the current user viewed the associated information of the preset content corresponding to the second target associated information last time. Having performed the view operation meeting the second preset condition may include: having performed the view operation for a second preset number or a second preset proportion of the historical associated information. The second preset number and the second preset proportion may be set as actually required, for example, respectively to 20 pieces and 100% or 90%, or the like. If the current user has viewed a certain number or a certain proportion of historical associated information, it is considered necessary to give the current user a prompt for the new associated information.

For example, the view operation meets a third preset condition, which may include that the view operation lasts for a preset duration or longer, for example. If the current user has performed a view operation for a certain duration for the historical associated information of the preset content corresponding to the second target associated information, which indicates that the current user is highly interested in the associated information of the preset content, a necessity is determined to give the current user a prompt for the new associated information.

By way of example, if the current user has posted associated information containing the first preset character for the preset content corresponding to the second target associated information, it is considered that the current user has a high degree of participation for, or is highly interested in, the associated information of the preset content, and a necessity is determined to provide the current user a prompt on the new associated information. The first preset character may be a character that presents a record or mark, for example, “Mark” or the like.

For example, the second preset duration can be set as actually required, for example, to 50 days. Within 50 days after the first preset prompt information is debuted, if the current user has not viewed the new associated information, entering the target interface can be performed again, and the second preset prompt information can continue to be displayed. If the duration reaches 50 days and the current user has not viewed the new associated information, display of the second preset prompt information can be cancelled, i.e., entering the target interface can be performed again, without displaying the second preset prompt information.

In some embodiments, in a case where the presented second target associated information meets the second preset requirement, displaying the second preset prompt information on the second association positon of the second target associated information, includes: in a case where the presented second target associated information meets the second preset requirement but does not meet a second preset filtering condition, displaying the second preset prompt information on the second associated position of the second target associated information. Such arrangement has the advantage of: on the basis of setting the second preset requirement, setting the second preset filtering condition, displaying the second preset prompt information if the second preset filtering condition is not hit, and reasonably displaying the second preset prompt information.

The second preset filtering condition includes: a poster of the second target associated information has a preset association relationship with the current user; a poster of a preset content corresponding to the second target associated information has the preset association relationship with the current user; the preset content corresponding to the second target associated information has a preset attribute. Such arrangement has the advantage of: reasonably setting the second preset filtering condition.

The preset association relationship may be a follow-up relationship or a friend relationship in a preset application, for example. If there exists a preset association relationship, new associated information is typically notified to the current user in the form of a push message or the like, to reduce redundant notifications of new associated information. By way of example, the preset attribute may be a type of the preset content or the like. For example, the preset content is a preset media work. If the preset media work is a video work of the notification type (e.g. an introduction of a new function) released by the preset application, it may be filtered out.

In some embodiments, after displaying the second preset prompt information, the method further includes: in response to a trigger operation for the second preset prompt information, entering a second preset presenting interface; and presenting at least one piece of the new associated information on the second preset presenting interface. Such arrangement has the advantage of: enabling a user to quickly view a new associated message. If a plurality of pieces of new associated information is presented, presenting is implemented in an ascending or descending chronological order.

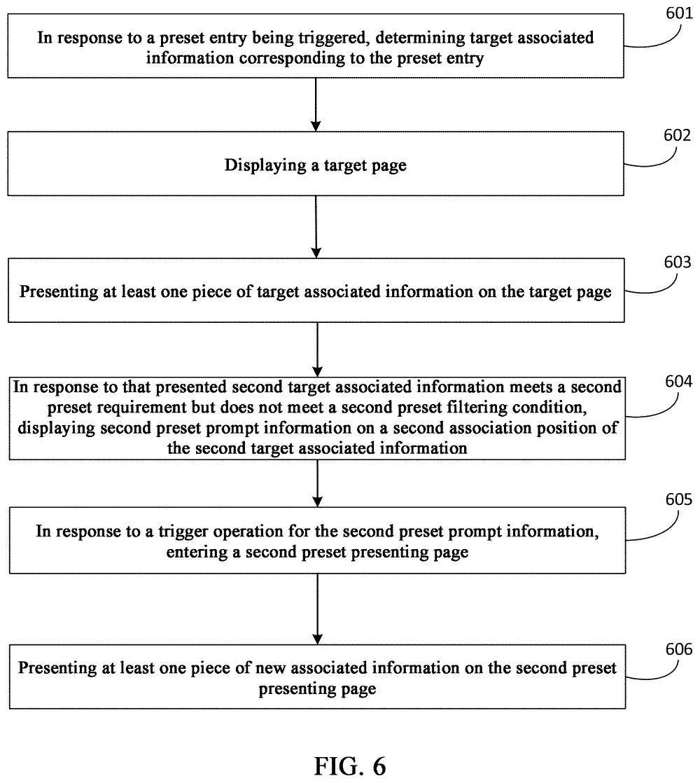

FIG. 6 illustrates a schematic flowchart of a further information presenting method provided by embodiments of the present disclosure where description will be made on the basis of the solution according to the embodiments described above. The method includes the following steps:

Step 601: in response to that the preset entry is triggered, determining the target associated information corresponding to the preset entry.

The associated information includes information associated with the preset content, and the target associated information includes associated information having a preset interaction relationship with the current user.

By way of example, the preset content is a preset media work, the associated information is comment information, and the preset interaction relationship is that a user has liked the comment.

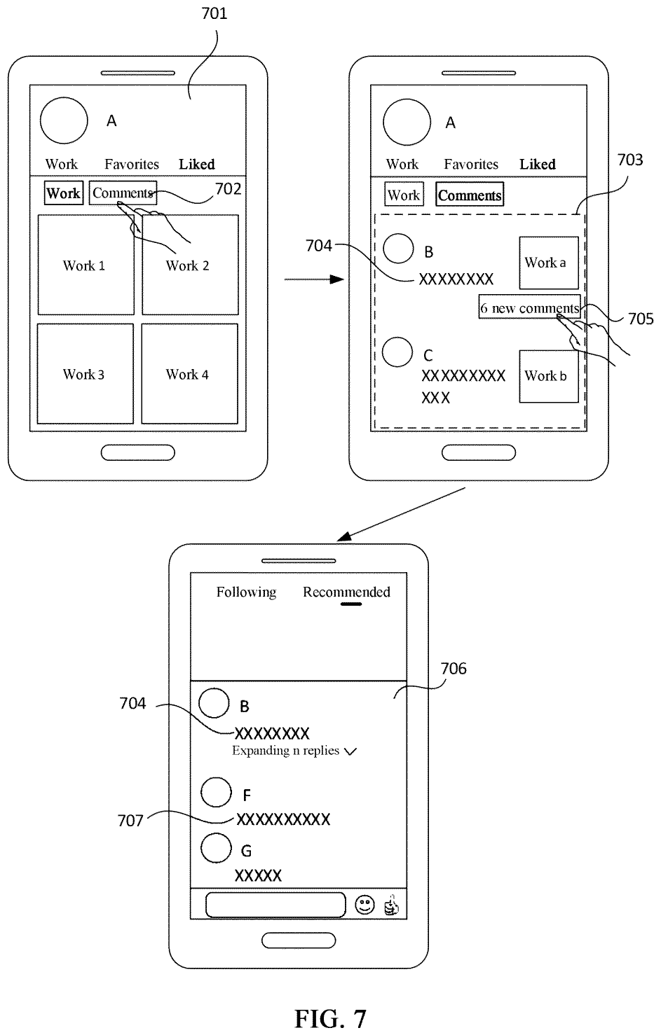

FIG. 7 illustrates a schematic diagram of further interface interaction provided by embodiments of the present disclosure. As shown therein, a preset entry 702 is displayed on a preset interface 701 (assuming that it is a personal homeinterface of a user A), and after the user clicks on the preset entry 702, target associated information corresponding to the preset entry 702 is determined, i.e., comment information that the user A has liked is determined.

Step 602: displaying the target interface.

As shown in FIG. 7, after the user clicks on the preset entry 702, entering the target interface 703 is implemented.

Step 603: displaying at least one piece of target associated information on the target interface.

As shown in FIG. 7, in the presence of the target associated information corresponding to the preset entry 702, at least one piece of target associated information is presented on the target interface 703, where two pieces of comment information liked by the user A are presented as an example in the figure.

Step 604: in a case where the presented second target associated information meets the second preset requirement but does not meet the second preset filtering condition, displaying the second preset prompt information on the second associated position of the second target associated information.

The second preset prompt information is configured indicate that the second target associated information contains new associated information that includes associated information posted after the preset interaction relationship being formed, having not been viewed by the current user, and meeting the preset presenting condition. The second preset prompt information includes a number of pieces of new associated information.

As shown in FIG. 7, if the second target associated information 704 (a comment posted by a user B) being presented meets the second preset requirement (for example, the user A has exhausted all comments existing at that time when viewing the comments on the work a last time, has viewed 20 comments or 50% of comments or has viewed the comments for 10 minutes, or the user A has posted associated information containing the first preset character, such as “Mark” or the like, for the work a), it is considered that the second target associated information 704 meets the second preset requirement. If the user A does not have the preset associated relationship with the user B, or with the poster of the work a, it is considered that the second target associated information 704 does not meet the second preset filtering condition. The second preset prompt information 705 is displayed on the associated position of the second target associated information 704, for example, at the lower right part of the second target associated information 704, and the content of the second preset prompt information 705 may be a number of new comments, for example, “new 6 comments” as shown in FIG. 7.

Step 605, in response to a trigger operation for the second preset prompt information, entering the second preset presenting interface.

As shown in FIG. 7, after the user clicks on the second preset prompt information 705, entering the second preset presenting interface 706 is implemented. The second preset presenting interface 706 may be a comment interface (also referred to as comments panel) on the preset content presenting interface, for example, a comments panel on the presenting interface of the work a.

Step 606: presenting at least one piece of new associated information on the second preset presenting interface.

As shown in FIG. 7, at least one new comment 707 is presented on the second preset presenting interface. Second target associated information 704 may also be displayed on the second preset presenting interface 706.

By way of example, after entering the second preset presenting interface, the new associated information is presented on the pinned position of the second preset presenting interface 706 (if the second target associated information 704 is displayed concurrently, the new associated information is displayed on a pinned position of the second preset presenting interface 706, except for the position of the second target associated information 704), and after the user inputs a switch operation such as swipe or the like, historical associated information may be presented.

The information presenting method provided by embodiments of the present disclosure includes: in response to that that the preset entry is triggered, determining target associated information corresponding to the preset entry; displaying the target interface; displaying at least one piece of target associated information on the target interface; in a case where the presented second target associated information meets the second preset requirement but does not meet the second preset filtering condition, displaying second preset prompt information on the second associated position of the second target associated information to prompt the user of the new associated information; after the user triggers the second preset prompt information, quickly jumping to the second preset presenting interface, to display the new associated information in association. In this way, the method can enable the user to quickly view new associated information, meet users' need for a convenient return visit to the new associated information, and improve the interaction efficiency.

In some embodiments, presenting at least one piece of the target associated information on the target interface includes: displaying at least two pieces of the target associated information in a preset sorting manner. The preset sorting manner includes at least one of the following: a sorting manner based on a chronological order of posting times; and a sorting manner based on numbers of users having the preset interaction relationship and corresponding to a same target associated information. This arrangement has the advantage of: reasonably presenting a plurality of pieces of target associated information in a certain order, to provide convenience for a user to view the target associated information.

The sorting manner based on a chronological order of posting times may include a sorting manner based on a positive chronological order of posting times, or a sorting manner based on a reversed chronological order of posting times. Filtering the target associated information posted within a specified period of time, or forming the preset interaction relationship during a specified period of time, can be supported.

The sorting manner based on numbers of users having the preset interaction relationship and corresponding to the same target associated information may include: for each target associated information, counting a total number of users having the preset interaction relationship therewith; and soring respective total numbers of users in an order from high to low, to enable a user to quickly view hot target associated information.

In some embodiments, the method further includes: displaying a content identifier of a preset content corresponding to the fifth target associated information on a third associated position of presented fifth target associated information. Such arrangement has the advantage of: enabling a user to quickly learn a corresponding relationship between target associated information and a preset content. Wherein, the content identifier may include a content summary, a screenshot or a cover image, or the like, of the preset content.

In some embodiments, after displaying the content identifier of a preset content corresponding to the fifth target associated information on the third associated position of the displayed fifth target associated information, the method further includes: in response to a trigger operation for the content identifier, entering a preset content presenting interface; and presenting a preset content corresponding to the fifth target associated information on the preset content presenting interface. Such arrangement has the advantage of: enabling a user to quickly view a preset content corresponding to target associated information of interest. For example, if the preset content is a video work, entering a video playback interface (a preset content presenting interface) implemented, where the video work is played.

In some embodiments, after presenting the preset content corresponding to the fifth target associated information on the content presenting interface, the method further includes: in response that an associated information presenting entry on the content presenting interface is triggered, entering the associated information presenting interface; setting, on the associated information presenting interface, a presenting progress of an associated information list as: presenting the fifth target associated information on a first target position. Such arrangement has the advantage of: enabling a user to quickly find the fifth target associated information on the associated information presenting interface after viewing the preset content, and then quickly view related information (e.g. associated information, interaction information, or the like) near the fifth target associated information.

The associated information is presented on the associated information presenting interface in the form of an associated information list, and a user can adjust the presenting progress of the associated information list by inputting a swipe operation, where the presenting progress may be Xth associated information in the associated information list presented on the first target position which may be, for example, a first position for presenting associated information on the associated information presenting interface.

In some embodiments, the method further includes: in response to a trigger operation for a presented third target associated information, entering an associated information presenting interface; setting, on the associated information presenting interface, a presenting progress of an associated information list as: presenting the third target associated information on a preset target position (also marked as second target position). Such arrangement has the advantage of: enabling a user to quickly enter the associated information presenting interface by triggering target associated information, find the triggered third target associated information therefrom, and further quickly view related information near the third target associated information. The second target position may be, for example, a first position for presenting associated information on the associated information presenting interface.

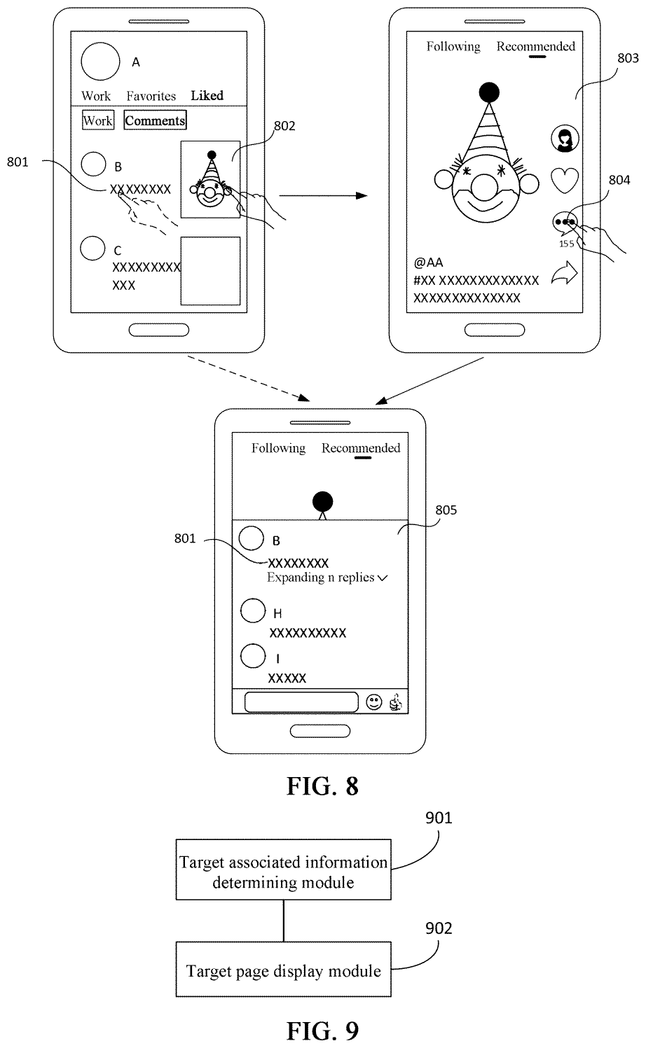

FIG. 8 illustrates a schematic diagram of still further interface interaction provided by embodiments of the present disclosure. As shown therein, target associated information 801 (a comment posted by a user B) and a content identifier 802 (e.g. a cover of a clown video) corresponding to a preset content are presented on a target interface. After the user clicks on the content identifier 802, a preset content presenting interface 803 is entered, where the clown video is played. After the user clicks on an associated information presenting entry 804 (a comment entry), an associated information presenting interface 805 (a comments panel) is entered, where a presenting progress of an associated information list (a comments list) is set as: presenting target associated information 801 on a first association information (comment information) presenting position. If the user clicks on the target associated information 801 on the target interface, the associated information presenting interface 805 can be directly entered, where a presenting progress of the associated information list (the comments list) is set as: presenting the target associated information 801 on the first associated information (comment information) presenting position.

In some embodiments, the method further includes: in response to a preset search request, searching for fourth target associated information matching a search keyword in the preset search request; and presenting the fourth target associated information. This arrangement has the advantage of: allowing a user to quickly find desired target associated information by searching a keyword, thus improving the efficiency of a return visit to the target associated information in a targeted manner.

The number of pieces of fourth target associated information may be one or more. If there are multiple pieces of fourth target associated information, a user can centrally view target associated information having something in common, for example, liked comments having something in common.

In some embodiments, the method further includes: in response to the preset search request, in a case of failing to find target associated information matching the search keyword in the preset search request, searching for recommended associated information matching the search keyword in the preset search request, where the recommended associated information does not have the preset interaction relationship with the current user; and presenting the recommended associated information, and/or presenting a content identifier of a recommended preset content corresponding to the recommended associated information. This arrangement has the advantage of: if target associated information hitting the search keyword is not found, recommending other associated information or preset content hitting the keyword to the current user.

While presenting the recommended associated information, a content identifier of a preset content corresponding to the recommended associated information is also presented, to enable a user to intuitively view the preset content of the recommended associated information. For example, a user enters a search keyword “beautiful scenery” to find tourist attractions. If comment information containing the search keyword is found in a comment liked by the user, the comment is presented preferentially; if no comment information containing the search keyword is found, comment information matching the search keyword among comments that the user has not liked is retrieved as recommended comment information, and the recommended comment information and a work identifier of a video work corresponding to the recommended comment information are presented, to enable a user to quickly view related video works and have some knowledge thereon.

FIG. 9 illustrates a schematic diagram of a structure of an information presenting apparatus provided by embodiments of the present disclosure. As shown therein, the apparatus includes a target associated information determining module 901 and a target interface display module 902.

The target associated information determining module 901 is configured to, in response to that a preset entry is triggered, determine target associated information corresponding to the preset entry, wherein the target associated information comprises associated information having a preset interaction relationship with a current user and comprising information associated with a preset content; and the target interface display module 902 is configured to display a target interface, wherein the target interface is configured present at least one piece of target associated information.

The information presenting apparatus provided by embodiments of the present disclosure can determine target associated information corresponding to a preset entry in response to that that the preset entry is triggered, where the target associated information comprises associated information having a preset interaction relationship with a current user and comprising information associated with a preset content, and display a target interface configured present at least one piece of target associated information. With the above technical solution, a preset entry is provided, such that a current user can conveniently view information associated with a preset content and having a preset interaction relationship with himself/herself, thereby making the associated information presenting methods more diversified, meeting the user's need for a return visit to target associated information, and improving the interaction efficiency.

The apparatus further includes:
a target associated information presenting module configured to present the at least one piece of target associated information on the target interface after displaying the target interface.

The apparatus further includes:
a first prompt information display module configured, in a case where first target associated information being presented meets a first preset requirement, to display first preset prompt information on a first associated position of the first target associated information, wherein the first preset prompt information is configured indicate that the first target associated information contains new interaction information that comprises interaction information posted after the preset interaction relationship being formed.

The new interaction information includes: interaction information posted after the preset interaction relationship being formed, for which the current user has not performed a view operation; and/or interaction information posted after the preset interaction relationship being formed and meeting a preset presenting condition.

The preset requirement includes at least one of the following:
for historical interaction information for the first target associated information, the current user has performed a view operation meeting a first preset condition; for the first target associated information, the current user has performed an interaction operation; and an effective duration of the first preset prompt information corresponding to the first target associated information is less than a first preset duration.

The first prompt information display module is configured to:
in a case where the first target associated information being presented meets the first preset requirement but does not meet a first preset filtering condition, display the first preset prompt information on the first associated position of the first target associated information.

The first preset filtering condition includes:
a poster of the first target associated information and/or a poster of a preset content corresponding to the first target associated information has a preset association relationship with the current user.

The first preset prompt information includes: a number of pieces of new interaction information.

The apparatus further includes:
a first preset presenting interface entering module configured to, after displaying the first preset prompt information, enter a first preset presenting interface in response to a trigger operation for the first preset prompt information; and a new interaction information presenting module configured to present at least one piece of new interaction information on the first preset presenting interface.

The new interaction information presenting module is configured to:
present the first target associated information on the first preset presenting interface, and present the at least one piece of new interaction information in an association area of the first target associated information.

The apparatus further includes:
a second prompt information display module configured, in a case where second target associated information being presented meets a second preset requirement, to display second preset prompt information on a second associated position of the second target associated information, wherein the second preset prompt information is configured indicate that a preset content corresponding to the second target associated information contains new associated information that comprises associated information posted after the present interaction relationship is formed.

The new associated information includes: associated information posted after the preset interaction relationship being formed, for which the current user has not performed a view operation; and/or associated information posted after the preset interaction relationship being formed and meeting a preset presenting condition.

The second preset requirement includes at least one of the following:
for historical associated information of a preset content corresponding to the second target associated information, the current user has performed a view operation meeting a second preset condition; a view operation performed by the current user for historical associated information of a preset content corresponding to the second target associated information meets a third preset condition; for a preset content corresponding to the second target associated information, the current user has posted associated information containing a first preset character; and an effective duration of the second preset prompt information corresponding to the second target associated information is less than a second preset duration.

The second prompt information display module is configured to:
in a case where the second target associated information being presented meets the second preset requirement but does not meet a second preset filtering condition, display the second preset prompt information on the second associated position of the second target associated information.

The second preset filtering condition includes at least one of the following:
a poster of the second target associated information has a preset association relationship with the current user; a poster of a preset content corresponding to the second target associated information has the preset association relationship with the current user; and the preset content corresponding to the second target associated information has a preset attribute.

The second preset prompt information includes: a number of pieces of the new associated information.

The apparatus further includes:
a second preset presenting interface entering module configured to, after displaying the second preset prompt information, enter a second preset presenting interface in response to a trigger operation for the second preset prompt information; and a new associated information presenting module configured to present the at least one piece of new associated information on the second preset presenting interface.

The preset presenting condition includes: not including a second preset character; and/or including more than preset image information.

The target associated information presenting module is configured to:
after displaying the target interface, present at least two pieces of the target associated information in a preset sorting manner; wherein the preset sorting manner comprises at least one of the following:
a sorting manner based on a chronological order of posting times; and a sorting manner based on numbers of users having the preset interaction relationship and corresponding to a same target associated information.

The apparatus further includes:
a content identifier display module configured to display, on a fifth associated position of presented fifth target associated information, a content identifier of a preset content corresponding to the fifth target associated information.

The apparatus further includes:
a preset content presenting interface entering module configured to, after displaying, on the fifth associated position of the presented fifth target associated information, the content identifier of the preset content corresponding to the fifth target associated information, enter a preset content presenting interface in response to a trigger operation for the content identifier of the preset content; and a preset content presenting module configured to present, on the preset content presenting interface, a preset content corresponding to the fifth target associated information.

The apparatus further includes:

a first associated information presenting interface entering module configured to, after presenting the preset content corresponding the fifth target associated information on the content presenting interface, enter an associated information presenting interface in response to that an associated information presenting entry on the content presenting interface is triggered; and a first presenting module configured to set, on the associated information presenting interface, a presenting progress of an associated information list as: presenting the fifth target associated information on a first target position.

The apparatus further includes:
a second associated information presenting interface entering module configured to, in response to a trigger operation for presented third target associated information, enter an associated information presenting interface; and a second presenting module configured to set, on the associated information presenting interface, a presenting progress of an associated information list as: presenting the third target associated information on a preset target position.

The apparatus further includes:
a first search module configured to, in response to a preset search request, search for fourth target associated information matching a search keyword in the preset search request; and a third presenting module configured to present the fourth target associated information.

The apparatus further includes:
a second search module configured to, in response to the preset search request, in a case of not finding target associated information matching the search keyword in the preset search request, search for recommended associated information matching the search keyword in the preset search request, wherein the recommended associated information does not have the preset interaction relationship with the current user; and a fourth presenting module configured to present the recommended associated information, and/or present a content identifier of a recommended preset content corresponding to the recommended associated information.

The apparatus is configured with at least one of the following:
the preset content includes a preset media work; the association information includes comment information; and the preset interaction relationship includes that a user has input a preset interaction operation for associated information, where the preset interaction operation comprises at least one of a like operation, an operation of adding to favorites, a mark operation, and a forwarding operation.

The image presenting apparatus provided by the embodiments of the present disclosure can perform the image presenting method provided by any of the embodiments of the present disclosure, which includes functional modules corresponding to the method and can achieve the corresponding effects.

A plurality of units and modules included in the above-mentioned apparatus is divided according to the functional logic, which are not confined to the above division as long as they can implement the respective functions. In addition, names of the plurality of functional units are employed only for differentiation from one another, without suggesting any limitation to the protection scope of the embodiments of the present disclosure.

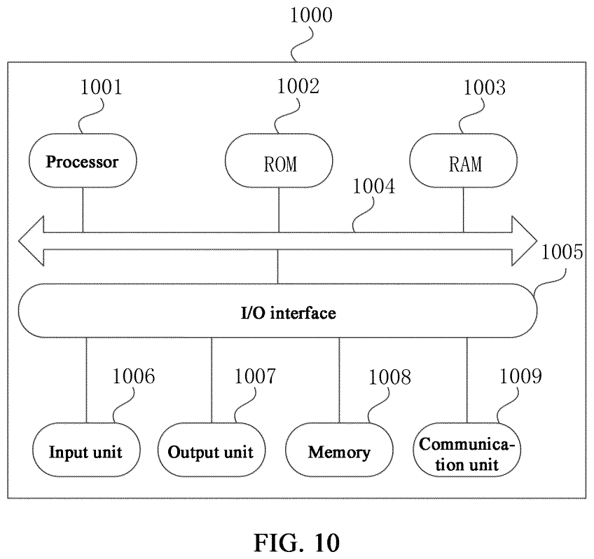

FIG. 10 illustrates a schematic diagram of a structure of an electronic device provided by embodiments of the present disclosure. Hereinafter, reference will be made to FIG. 10 that illustrates a schematic diagram of a structure of an electronic device (e.g. a terminal device or server in FIG. 10) 1000 adapted to implement embodiments of the present disclosure. The terminal device according to the embodiments of the present disclosure may include a mobile terminal such as a mobile phone, a laptop computer, a digital broadcast receiver, a Personal Digital Assistant (PDA), a Portable Android Device (PAD), a Portable Media Player (PMP), an on-vehicle terminal (e.g. an on-vehicle navigation terminal) or the like, or a fixed terminal such as a digital television (TV), a desktop computer or the like. The electronic device 1000 as shown in FIG. 10 is provided merely as an example, without suggesting any limitation to the functions and the application range of the embodiments of the present disclosure.

As shown therein, the electronic device 1000 may include a processor (e.g. a central processor, a graphics processor or the like) 1001, which can execute various acts and processing based on programs stored in a Read Only Memory (ROM) 1002 or a program loaded from a storage unit 1008 to a Random Access Memory (RAM) 1003. RAM 1003 stores therein various programs and data required for operations of the electronic device 1000. The processor 1001, the ROM 1002 and the RAM 1003 are connected to one another via a bus 1004. An input/output (I/O) interface 1005 is also connected to the bus 1004.

Typically, the following units may be connected to the I/O interface 1005: an input unit 1006 including, for example, a touchscreen, a touch pad, a keyboard, a mouse, a camera, a microphone, an accelerometer, a gyroscope and the like; an output unit 1007 including, for example, a Liquid Crystal Display (LCD), a loudspeaker, a vibrator and the like; a storage unit 1008 including, for example, a tape, a hard drive and the like; and a communication unit 1009. The communication unit 1009 can allow wireless or wired communication of the electronic device 1000 with other devices to exchange data. Although FIG. 10 shows the electronic device 1000 including various units, it would be appreciated that not all of the units as shown are required to be implemented or provided. Alternatively, more or fewer units may be implemented or provided.

In particular, according to embodiments of the present disclosure, the processes described above with reference to the flowchart may be implemented as a computer software program. For example, embodiments of the present disclosure include a computer program product comprising computer programs carried on a non-transitory computer readable medium, the computer program containing program code for performing the method as shown in the flowchart. In those embodiments, the computer program may be downloaded and installed from a network via the communication unit 1009, or may be installed from the storage unit 1008, or may be installed from the ROM 1002. The computer program, when executed by the processor 1001, performs the above-described functions defined in the method according to the embodiments of the present disclosure.

Names of messages or information interacted between a plurality of apparatuses in the embodiments of the present disclosure are illustrative rather than limit the scope of the messages or information.

The electronic device provided by the embodiments of the present disclosure belongs to the same invention conception as the image presenting method provided by the above-mentioned embodiments. For the technical details not exhausted here, see the above-mentioned embodiments, and these embodiments can achieve the same advantageous effect as the above-mentioned embodiments.

The embodiments of the present disclosure provide a computer storage medium having a computer program stored thereon, where the program, when executed by a processor, implements the image presenting method provided by the above-mentioned embodiments.

The computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, an RAM, an ROM, an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example, the internet), a peer-to-peer network (e.g. ad hoc peer-to-peer network), and any known network or network to be developed.

The computer-readable medium may be the one included in the electronic device, or may be provided separately, rather than assembled in the electronic device.

The computer-readable medium carries one or more programs which, when executed by the electronic device, cause the electronic device to: in response to that a preset entry is triggered, determine target associated information corresponding to the preset entry, wherein the target associated information comprises associated information having a preset interaction relationship with a current user and comprising information associated with a preset content; and display a target interface, wherein the target interface is configured present at least one piece of target associated information.

Computer program code for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program code may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowchart and block diagrams in the drawings illustrate the architecture, functionality and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

Related units for describing the embodiments of the present disclosure may be implemented in the form of software, or may be implemented in the form of hardware. In certain circumstances, the names of units/modules do not formulate limitation to the units per se. For example, the target interface display module may also be described as “a module for displaying a target interface, wherein the target interface is configured present at least one of piece of the target associated information.”

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, an RAM, an ROM, an EPROM or flash memory, an optical fiber, a CD-ROM, an optical storage device, a magnetic storage device, or any suitable combination of the foregoing.

According to one or more embodiments of the present disclosure, there is provided an information presenting method, comprising:
in response to that a preset entry is triggered, determining target associated information corresponding to the preset entry, wherein the target associated information comprises associated information having a preset interaction relationship with a current user and comprising information associated with a preset content; and
displaying a target interface, wherein the target interface is configured present at least one piece of target associated information.

According to one or more embodiments of the present disclosure, after displaying the target interface, the method further comprises:
presenting the at least one piece of target associated information on the target interface.

According to one or more embodiments of the present disclosure, the method further comprises:
in a case where first target associated information being presented meets a first preset requirement, displaying first preset prompt information on a first associated position of the first target associated information, wherein the first preset prompt information is configured indicate that the first target associated information contains new interaction information that comprises interaction information posted after the preset interaction relationship being formed.

According to one or more embodiments of the present disclosure, the new interaction information comprises: interaction information posted after the preset interaction relationship being formed, for which the current user has not performed a view operation; and/or interaction information posted after the preset interaction relationship being formed and meeting a preset presenting condition.

According to one or more embodiments of the present disclosure, the first preset requirement comprises at least one of the following:
for historical interaction information for the first target associated information, the current user has performed a view operation meeting a first preset condition;
for the first target associated information, the current user has performed an interaction operation; and
an effective duration of the first preset prompt information corresponding to the first target associated information is less than a first preset duration.

According to one or more embodiments of the present disclosure, in the case where the first target associated information being presented meets the first preset requirement, displaying the first preset prompt information on the first associated position of the first target associated information, comprises:
in a case where the first target associated information being presented meets the first preset requirement but does not meet a first preset filtering condition, displaying the first preset prompt information on the first associated position of the first target associated information.

According to one or more embodiments of the present disclosure, the first preset filtering condition comprises:
a poster of the first target associated information and/or a poster of a preset content corresponding to the first target associated information has a preset association relationship with the current user.

According to one or more embodiments of the present disclosure, the first preset prompt information comprises a number of pieces of new interaction information.

According to one or more embodiments of the present disclosure, after displaying the first preset prompt information, the method further comprises:
in response to a trigger operation for the first preset prompt information, entering a first preset presenting interface; and
presenting at least one piece of new interaction information on the first preset presenting interface.

According to one or more embodiments of the present disclosure, presenting the at least one piece of new interaction information on the first preset presenting interface comprises:
presenting the first target associated information on the first preset presenting interface, and presenting the at least one piece of new interaction information in an association area of the first target associated information.

According to one or more embodiments of the present disclosure, the method further comprises:
in a case where second target associated information being presented meets a second preset requirement, displaying second preset prompt information on a second associated position of the second target associated information, wherein the second preset prompt information is configured indicate that a preset content corresponding to the second target associated information contains new associated information that comprises associated information posted after the present interaction relationship is formed.

According to one or more embodiments of the present disclosure, the new associated information comprises: associated information posted after the preset interaction relationship being formed, for which the current user has not performed a view operation; and/or associated information posted after the preset interaction relationship being formed and meeting a preset presenting condition.

According to one or more embodiments of the present disclosure, the second preset requirement comprises at least one of the following:
for historical associated information of a preset content corresponding to the second target associated information, the current user has performed a view operation meeting a second preset condition;
a view operation performed by the current user for historical associated information of a preset content corresponding to the second target associated information meets a third preset condition;
for a preset content corresponding to the second target associated information, the current user has posted associated information containing a first preset character; and
an effective duration of the second preset prompt information corresponding to the second target associated information is less than a second preset duration.

According to one or more embodiments of the present disclosure, in the case where the second target associated information being presented meets the second preset requirement, displaying the second preset prompt information on the second associated position of the second target associated information, comprises:
in a case where the second target associated information being presented meets the second preset requirement but does not meet a second preset filtering condition, displaying the second preset prompt information on the second associated position of the second target associated information.

According to one or more embodiments of the present disclosure, the second preset filtering condition comprises at least one of the following:
a poster of the second target associated information has a preset association relationship with the current user;
a poster of a preset content corresponding to the second target associated information has the preset association relationship with the current user; and
the preset content corresponding to the second target associated information has a preset attribute.

According to one or more embodiments of the present disclosure, the second preset prompt information comprises: a number of pieces of the new associated information.

According to one or more embodiments of the present disclosure, after displaying the second preset prompt information, the method further comprises:
in response to a trigger operation for the second preset prompt information, entering a second preset presenting interface; and
presenting at least one new associated information on the second preset presenting interface.

According to one or more embodiments of the present disclosure, presenting the at least one piece of target associated information on the target interface comprises:
presenting at least two pieces of target associated information in a preset sorting manner;
wherein the preset sorting manner comprises at least one of the following:

a sorting manner based on a chronological order of posting times; and
a sorting manner based on numbers of users having the preset interaction relationship and corresponding to a same target associated information.

According to one or more embodiments of the present disclosure, the method further comprises:
in response to a trigger operation for a third target associated information being presented, entering an associated information presenting interface; and
setting, on the associated information presenting interface, a presenting progress of an associated information list as: presenting the third target associated information on a preset target position.

According to one or more embodiments of the present disclosure, the method further comprises:
in response to a preset search request, searching for fourth target associated information matching a search keyword in the preset search request; and
presenting the fourth target associated information.

According to one or more embodiments of the present disclosure, the method further comprises:
in response to the preset search request, in a case of not finding target associated information matching the search keyword in the preset search request, searching for recommended associated information matching the search keyword in the preset search request, wherein the recommended associated information does not have the preset interaction relationship with the current user; and
presenting at least one of the following: the recommended associated information, and/or a content identifier of a recommended preset content corresponding to the recommended associated information.

According to one or more embodiments of the present disclosure, at least one of the following is met:
the preset content comprises a preset media work;
the associated information comprises comment information; and
the preset interaction relationship comprises that a user has input a preset interaction operation for associated information, the preset interaction operation comprising at least one of a like operation, an operation of adding to favorites, a mark operation, and a forwarding operation.

According to one or more embodiments of the present disclosure, there is provided an information presenting apparatus, comprising:
a target associated information determining module configured to, in response to that a preset entry is triggered, determine target associated information corresponding to the preset entry, wherein the target associated information comprises associated information having a preset interaction relationship with a current user and comprising information associated with a preset content; and
a target interface display module configured to display a target interface, wherein the target interface is configured present at least one piece of target associated information.

According to one or more embodiments of the present disclosure, there is provided an electronic device, comprising:
one or more processors; and
a memory configured to store one or programs;
wherein the one or more programs, when executed by the one or more processors, cause the one or more processors to implement the information presenting method provided by the embodiments of the present disclosure.

According to one or more embodiments of the present disclosure, there is provided a storage medium comprising computer executable instructions which, when executed by a computer processor, implement the information presenting method provided by the embodiments of the present disclosure.

According to one or more embodiments of the present disclosure, there is provided a computer program product comprising a computer program carried on a non-transitory computer readable medium, wherein the computer program comprises program code for executing the information presenting method provided by the embodiments of the present disclosure.

Further, while operations are depicted in a particular order, this should not be understood as requiring that such operations be performed in the particular order shown or in sequential order. In certain circumstances, multitasking and parallel processing may be advantageous. Likewise, while several specific implementation details are contained in the above discussions, these should not be construed as limitations on the scope of the present disclosure, but rather as descriptions of features that may be specific to particular implementations. Certain features that are described in the context of separate embodiments may also be implemented in combination in a single embodiment. Conversely, various features that are described in the context of a single embodiment may also be implemented in multiple embodiments separately or in any suitable sub-combination.

1. An information presentation method, comprising:
in response to that a preset entry is triggered, determining target associated information corresponding to the preset entry, wherein the target associated information comprises associated information having a preset interaction relationship with a current user and comprising information associated with a preset content; and
displaying a target interface, wherein the target interface is configured to present at least one piece of target associated information.

2. The method of claim 1, further comprising, after displaying the target interface:
presenting the at least one piece of target associated information on the target interface.

3. The method of claim 2, further comprising:
in response to first target associated information being presented meets a first preset requirement, displaying first preset prompt information on a first associated position of the first target associated information, wherein the first preset prompt information is configured to indicate that the first target associated information contains new interaction information that comprises interaction information posted after the preset interaction relationship being formed.

4. The method of claim 3, wherein the new interaction information comprises at least one of the following:
interaction information posted after the preset interaction relationship being formed, for which the current user has not performed a view operation; or
interaction information posted after the preset interaction relationship being formed and meeting a preset presenting condition.

5. The method of claim 3, wherein the first preset requirement comprises at least one of the following:
for historical interaction information for the first target associated information, the current user has performed a view operation meeting a first preset condition;
for the first target associated information, the current user has performed an interaction operation; or
an effective duration of the first preset prompt information corresponding to the first target associated information is less than a first preset duration.

6. The method of claim 3, wherein, in response to the first target associated information being presented meets the first preset requirement, displaying the first preset prompt information on the first associated position of the first target associated information, comprises:
in response to the first target associated information being presented meets the first preset requirement but does not meet a first preset filtering condition, displaying the first preset prompt information on the first associated position of the first target associated information.

7. The method of claim 6, wherein the first preset filtering condition comprises:
at least one of a poster of the first target associated information and a poster of preset content corresponding to the first target associated information has a preset associated relationship with the current user.

8. The method of claim 3, wherein the first preset prompt information comprises a number of pieces of new interaction information.

9. The method of claim 3, further comprising, after displaying the first preset prompt information:
in response to a trigger operation for the first preset prompt information, entering a first preset presenting interface; and
presenting at least one piece of new interaction information on the first preset presenting interface.

10. The method of claim 9, wherein presenting the at least one piece of new interaction information on the first preset presenting interface comprises:
presenting the first target associated information on the first preset presenting interface, and presenting the at least one piece of new interaction information in an associated area of the first target associated information.

11. The method of claim 2, further comprising:
in response to second target associated information being presented meets a second preset requirement, displaying second preset prompt information on a second associated position of the second target associated information, wherein the second preset prompt information is configured to indicate that preset content corresponding to the second target associated information contains new associated information that comprises associated information posted after the present interaction relationship is formed.

12. The method of claim 11, wherein the new associated information comprises at least one of the following:
associated information posted after the preset interaction relationship being formed, for which the current user has not performed a view operation; or
associated information posted after the preset interaction relationship being formed and meeting a preset presenting condition.

13. The method of claim 11, wherein the second preset requirement comprises at least one of the following:
for historical associated information of a preset content corresponding to the second target associated information, the current user has performed a view operation meeting a second preset condition;
a view operation performed by the current user for historical associated information of preset content corresponding to the second target associated information meets a third preset condition;
for preset content corresponding to the second target associated information, the current user has posted associated information containing a first preset character; or
an effective duration of the second preset prompt information corresponding to the second target associated information is less than a second preset duration.

14. The method of claim 11, wherein, in response to the second target associated information being presented meets the second preset requirement, displaying the second preset prompt information on the second associated position of the second target associated information, comprises:
in response to the second target associated information being presented meets the second preset requirement but does not meet a second preset filtering condition, displaying the second preset prompt information on the second associated position of the second target associated information,
wherein the second preset prompt information comprises: a number of pieces of the new associated information.

15. The method of claim 14, wherein the second preset filtering condition comprises at least one of the following:
a poster of the second target associated information has a preset associated relationship with the current user;
a poster of preset content corresponding to the second target associated information has the preset associated relationship with the current user; or
the preset content corresponding to the second target associated information has a preset attribute.

16. (canceled)

17. The method of claim 11, further comprising, after displaying the second preset prompt information:
in response to a trigger operation for the second preset prompt information, entering a second preset presenting interface; and
presenting at least one new associated information on the second preset presenting interface,
wherein presenting the at least one piece of target associated information on the target interface comprises:
presenting at least two pieces of target associated information in a preset sorting manner;
wherein the preset sorting manner comprises at least one of the following:
a sorting manner based on a chronological order of posting times; or
a sorting manner based on numbers of users having the preset interaction relationship and corresponding to a same target associated information.

18. (canceled)

19. The method of claim 2, further comprising:
in response to a trigger operation for a third target associated information being presented, entering an associated information presenting interface; and
setting, on the associated information presenting interface, a presenting progress of an associated information list as: presenting the third target associated information on a preset target position,
wherein at least one of the following is met:
the preset content comprises a preset media work;
the associated information comprises comment information; or
the preset interaction relationship comprises that a user has input a preset interaction operation for associated information, the preset interaction operation comprising at least one of a like operation, an operation of adding to favorites, a mark operation, or a forwarding operation.

20. The method of claim 1, further comprising:
in response to a preset search request, searching for fourth target associated information matching a search keyword in the preset search request; and
presenting the fourth target associated information,
wherein the method further comprising:
in response to the preset search request, in a case of not finding target associated information matching the search keyword in the preset search request, searching for recommended associated information matching the search keyword in the preset search request, wherein the recommended associated information does not have the preset interaction relationship with the current user; and
presenting at least one of the following: the recommended associated information; or a content identifier of recommended preset content corresponding to the recommended associated information.

21. (canceled)

22. (canceled)

23. (canceled)

24. (canceled)

25. An electronic device, comprising:
at least one processor; and
a memory configured to store at least one program;
wherein the at least one program, when executed by the at least one processor, causes the at least one processor to:
in response to that a preset entry is triggered, determine target associated information corresponding to the preset entry, wherein the target associated information comprises associated information having a preset interaction relationship with a current user and comprising information associated with a preset content; and
display a target interface, wherein the target interface is configured to present at least one piece of target associated information.

26. A non-transitory storage medium comprising computer executable instructions, when executed by one or more computer processors, the computer executable instructions cause the one or more computer processors to:
in response to that a preset entry is triggered, determine target associated information corresponding to the preset entry, wherein the target associated information comprises associated information having a preset interaction relationship with a current user and comprising information associated with a preset content; and
display a target interface, wherein the target interface is configured to present at least one piece of target associated information.

27. (canceled)
